(19) United States
(12) Patent Application Publication
(10) Pub. No.: US 2011/0084617 A1
(43) Pub. Date: Apr. 14, 2011

(54) High reliability and long lifetime AC LED device

(75) Inventors: Pei-Hsuan Lan, Banciao City (TW); Jen-Hua Yang, Luodong Township (TW)

(73) Assignee: Forward Electronics Co., Ltd., Taipei City (TW)

(21) Appl. No.: 12/591,762

(22) Filed: Dec. 1, 2009

(30) Foreign Application Priority Data
Oct. 8, 2009 (TW) 098218531

(51) Int. Cl. H05B 37/02

(52) U.S. Cl. 315/185 R

(57) ABSTRACT

A high reliability and long lifetime AC LED device includes: an LED group, a rectifier diode group and an AC power. The LED group includes a plurality of LED micro-chips connected in series. The rectifier diode group includes four rectifier diodes. The AC power is electrically connected to the rectifier diode group, and the rectifier diode group is electrically connected to the LED group. The AC power includes a positive half-cycle voltage and a negative half-cycle voltage. The rectifier diode group enables the LED group to conduct both in positive and negative half-cycle voltage, so as to prevent the LED group from bearing high reverse bias voltage, and extend the light-emitting lifetime and enhance the reliability.

### BACKGROUND OF THE INVENTION

1. Field of the Invention

The invention relates to an AC LED device and, more particularly, to a high reliability and long lifetime AC LED device.

2. Description of Related Art

As the widespread use of LED, an AC LED has been developed for being directly connected to an AC power supply terminal, so as to overcome the problem that LED cannot be powered by AC power directly. However, there are still some problems needed to be improved in AC LED manufacturing process; for example, the reverse bias voltage in AC LED may cause LED to generate reverse high voltage leakage current.

As shown in FIG. 1, the conventional AC LED is accomplished by arranging a plurality of LEDs in a bridge-rectifier configuration. When the AC power 10 is in the positive half-cycle, the LED blocks, denoted by “a”, “e” and “c” are turned on, and the LED blocks, denoted by “b” and “d” would bear reverse bias voltage. When the AC power 10 is in the negative half-cycle, the LED blocks, denoted by “b”, “e” and “d” are turned on, and the LED blocks denoted by “a” and “c” would bear reverse bias voltage. Therefore, the LED blocks “a” and “c”, and the LED blocks “b” and “d” alternately bear reverse bias voltage in this arrangement. If the reverse bias voltage of the LED block is too high, it will generate high reverse bias voltage leakage current that leads to LED chip breakdown, resulting in short light-emitting lifetime and low reliability.

Besides, the LED blocks of the conventional AC LED are not turned on to illuminate at the same time. When the AC power 10 is in the positive half-cycle, only the LED blocks “a”, “e” and “c” are turned on to illuminate. When the AC power 10 is in the negative half-cycle, only the LED blocks “b”, “e” and “d” are turned on to illuminate. Consequently, there are no more than two-thirds of the AC LED blocks in the conventional arrangement to be turned on to illuminate. Further, owing to that the LED blocks of the conventional AC LED are turned on and off alternately, it is likely to generate light flash as the illuminations of the LED blocks are changed alternately.

Therefore, it is desirable to provide an improved AC LED device to mitigate the aforementioned problems.

### SUMMARY OF THE INVENTION

The object of the present invention is to provide an AC LED device to overcome the reverse bias high voltage leakage current and light flash generated from the conventional bridge-rectifier configured AC LED device.

To achieve this object, there is provided a high reliability and long lifetime AC LED device, which comprises: an LED group composed of a plurality of LED micro-chips connected in series and having an anode and a cathode; a rectifier diode group composed of a first rectifier diode, a second rectifier diode, a third rectifier diode and a forth rectifier diode, each rectifier diode having an anode and a cathode, the cathode of the first rectifier diode being connected to the cathode of the second rectifier diode and the anode of the LED group, the anode of the second rectifier diode being connected to the cathode of the third rectifier diode, the anode of the third rectifier diode being connected to the anode of the forth rectifier diode and the cathode of the LED group, the cathode of the forth rectifier diode being connected to the anode of the first rectifier diode; and an AC power source electrically connected to the anode of the first rectifier diode and the cathode of the third rectifier diode of the rectifier diode group; wherein the AC power source provides a positive half-cycle voltage and a negative half-cycle voltage, and the rectifier diode group enables the LED group to be turned on both in the positive half-cycle voltage and the negative half-cycle voltage.

Other objects, advantages, and novel features of the invention will become more apparent from the following detailed description when taken in conjunction with the accompanying drawings.

### BRIEF DESCRIPTION OF THE DRAWINGS

FIG. 1 schematically illustrates a conventional AC LED device;

FIG. 2 is a schematic diagram of the high reliability and long lifetime AC LED device in accordance with an embodiment of the present invention;

FIG. 3 shows a system block diagram of the high reliability and long lifetime AC LED device in accordance with an embodiment of the present invention;

FIG. 4(A) shows a matrix pattern arrangement of the LED micro-chips in accordance with an embodiment of the present invention;

FIG. 4(B) shows a nun-matrix pattern arrangement of the LED micro-chips in accordance with an embodiment of the present invention;

FIG. 5 shows a wire-bonded frame diagram in accordance with an embodiment of the present invention.

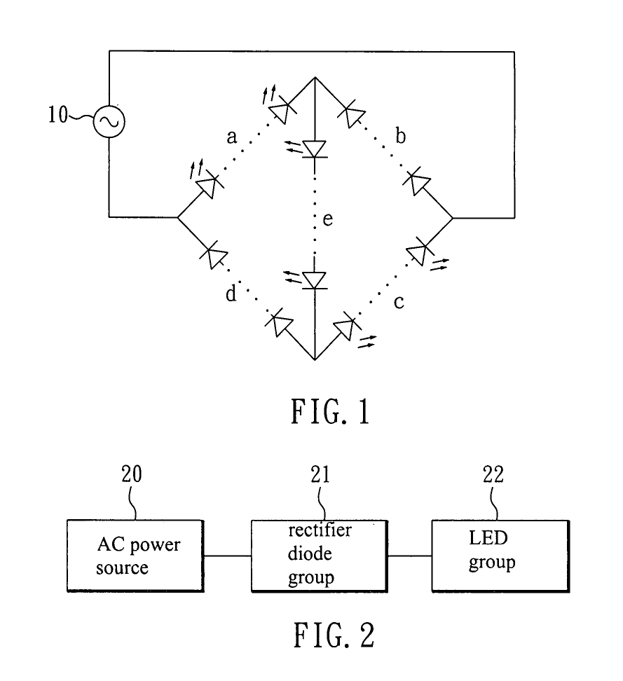

### DETAILED DESCRIPTION OF THE PREFERRED EMBODIMENT

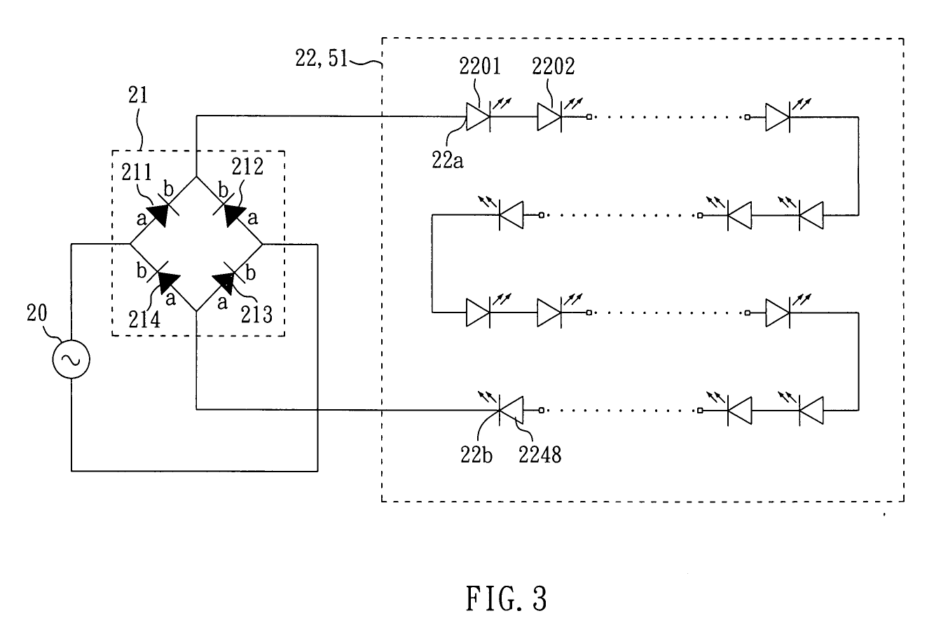

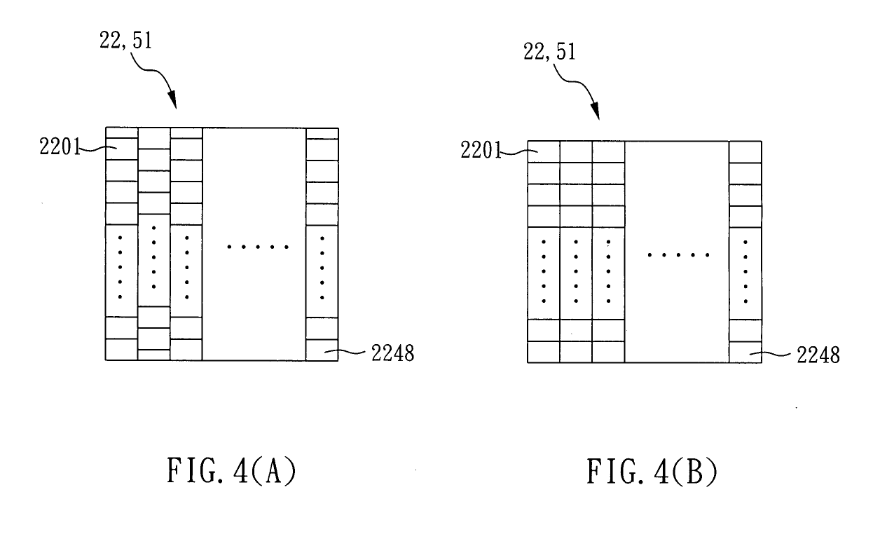

With reference to FIGS. 2 and 3, FIG. 2 is a schematic diagram of the high reliability and long lifetime AC LED device in accordance with one preferred embodiment of the present invention, and FIG. 3 is a system block diagram of the high reliability and long lifetime AC LED device in accordance with one preferred embodiment of the present invention. As shown in FIGS. 2 and 3, the high reliability and long lifetime AC LED device of the present invention includes a rectifier diode group 21, an LED group 22 and an AC power source 20. The LED group 22 is composed of a plurality of LED micro-chips connected in series. Preferably, there are 48 LED micro-chips 2201-2248 connected in the LED group 22, and the 48 LED micro-chips 2201-2248 are manufactured in one chip 51. The LED micro-chips 2201-2248 are arranged in a matrix pattern, as shown in FIG. 4(A); or the LED micro-chips 2201-2248 are arranged in a non-matrix pattern, as shown in FIG. 4(B).

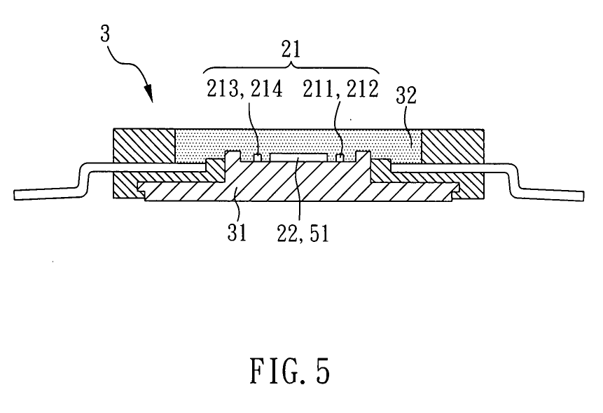

With reference to FIG. 3 and FIG. 5, which shows a wire-bonded frame diagram of the AC LED device, the rectifier diode group 21 is composed of a first rectifier diode 211, a second rectifier diode 212, a third rectifier diode 213 and a forth rectifier diode 214. Each of the rectifier diodes 211-214 is a component of diode device, and this component of diode device is a high-voltage rectifier diode. Preferably, the rectifier diode group 21 and the LED group 22 are integrated into one chip package 3, and they are wire-bonded on a frame 31. As shown in FIGS. 3 and 5, the rectifier diode 211-214 of the rectifier diode group 21 and the LED group 22 are arranged on the same frame 31, and packaged by a sealing compound 32 to form a package structure.

With reference to FIGS. 2 and 3 again, the LED group 22 is comprised of 48 LED micro-chips 2201-2248 connected in series, while the number of LED micro-chips required is calculated from the on voltages of the LED micro-chips 2201-2248, the on voltages of the rectifier diode 211-214 and the voltage of the AC power source 20. In this embodiment, the voltage provided by the AC power source 20 is 110V, which is a root mean square value. The peak value of the voltage is the root mean square value multiplied by root of 2, i.e., 156V. Each of the rectifier diode 211-214 in this embodiment has an on voltage of 1V, and each of the LED micro-chips 2201-2248 has an on voltage of 3.2V. When the AC power source 20 is in the positive half-cycle, the current passes through the first rectifier diode 211, the LED group 22 and the third rectifier diode 213. When the AC power source 20 is in the negative half-cycle, the current passes through the second rectifier diode 212, the LED group 22 and the forth rectifier diode 214. Because the current of the AC power source 20 passes two rectifier diodes both in the negative and positive half-cycle, the voltage drop is 2V. Therefore, the number of the LED micro-chips in the LED group 22 is calculated from the following formula: (156−1*2)/3.2=48; i.e., the LED group 22 includes 48 LED micro-chips.

As the 48 LED micro-chips are connected in series, there are an anode 22a and a cathode 22b in the LED group 22. Each of the rectifier diodes 211-214 has an anode and a cathode. The cathode 211b of the first rectifier diode 211 is connected to the cathode 212b of the second rectifier diode 212 and the anode 22a of the LED group 22. The anode 212a of the second rectifier diode 212 is connected to the cathode 213b of the third rectifier diode 213. The anode 213a of the third rectifier diode 213 is connected to the anode 214a of the forth rectifier diode 214 and the cathode 22b of the LED group 22. The cathode 214b of the forth rectifier diode 214 is connected to the anode 211a of the first rectifier diode 211.

With the high reliability and long lifetime AC LED device of the present invention, when the AC power source 20 is in the positive half-cycle, the first rectifier diode 211 and the third rectifier diode 213 are turned on, so as to enable the LED group 22 to be turned on. Similarly, when the AC power source 20 is in the negative half-cycle, the second rectifier diode 212 and the forth rectifier diode 214 are turned on, so as to enable the LED group 22 to be turned on. Therefore, the rectifier diode group 21 enables the LED group 22 to be turned on both in the positive half-cycle and negative half-cycle so as to illuminate all LED micro-chips 2201-2248 of the LED group 22.

Furthermore, when the AC power source 20 is in the positive half-cycle, the current passes through the first rectifier diode 211, the LED group 22 and the third rectifier diode 213. The second rectifier diode 212 and the forth rectifier diode 214 are turned off, and thus bear a reverse voltage respectively. When the AC power source 20 is in the negative half-cycle, the current passes through the second rectifier diode 212, the LED group 22 and the forth rectifier diode 214. The first rectifier diode 211 and the third rectifier diode 213 are turned off, and thus bear a reverse voltage respectively.

The high reliability and long lifetime AC LED device of the present invention is provided with the rectifier diodes 211-214 that could bear reverse voltage up to 600-1000V, and the reverse leakage current of the rectifier diodes 211-214 is reduced to the scale of several μA. Therefore, the use of the rectifier diodes 211-214 in accordance with the present invention can avoid the reverse bias breakdown leakage current generated by the reverse bias high voltage leakage current generated by the bridge-rectifier configured AC LED micro-chips of the conventional AC LED device, so as to extend the light-emitting lifetime and enhance the reliability.

Although the present invention has been explained in relation to its preferred embodiment, it is to be understood that many other possible modifications and variations can be made without departing from the spirit and scope of the invention as hereinafter claimed.

What is claimed is:

1. A high reliability and long lifetime AC LED device comprising:
an LED group composed of a plurality of LED micro-chips connected in series and having an anode and a cathode;
a rectifier diode group composed of a first rectifier diode, a second rectifier diode, a third rectifier diode and a forth rectifier diode, each rectifier diode having an anode and a cathode, the cathode of the first rectifier diode being connected to the cathode of the second rectifier diode and the anode of the LED group, the anode of the second rectifier diode being connected to the cathode of the third rectifier diode, the anode of the third rectifier diode being connected to the anode of the forth rectifier diode and the cathode of the LED group, the cathode of the forth rectifier diode being connected to the anode of the first rectifier diode; and
an AC power source electrically connected to the anode of the first rectifier diode and the cathode of the third rectifier diode of the rectifier diode group;
wherein the AC power source provides a positive half-cycle voltage and a negative half-cycle voltage, and the rectifier diode group enables the LED group to be turned on both in the positive half-cycle voltage and the negative half-cycle voltage.

2. The high reliability and long lifetime AC LED device of claim 1, wherein the plurality of LED micro-chips of the LED group are manufactured in a chip.

3. The high reliability and long lifetime AC LED device of claim 1, wherein the first rectifier diode, the second rectifier diode, the third rectifier diode and the forth rectifier diode are diode devices respectively.

4. The high reliability and long lifetime AC LED device of claim 3, wherein each of the diode devices is a high-voltage rectifier diode.

5. The high reliability and long lifetime AC LED device of claim 1, wherein the LED group and the rectifier diode group are integrated into a chip package.

6. The high reliability and long lifetime AC LED device of claim 5, wherein the plurality of LED micro-chips of the LED group are arranged in a non-matrix pattern.

7. The high reliability and long lifetime AC LED device of claim 5, wherein the LED group and the rectifier diode group are wire-bonded on a frame.
